(19) United States
(12) Patent Application Publication
(10) Pub. No.: US 2005/0050448 A1
(43) Pub. Date: Mar. 3, 2005

(54) Systems and methods for providing support to a user regarding media usage

(76) Inventor: Dave R. Dehart, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,533

(22) Filed: Aug. 29, 2003

(51) Int. Cl. G06F 17/00

(52) U.S. Cl. 715/501.1

(57) ABSTRACT

Disclosed are systems and methods for providing media usage support to a device user. In one embodiment, a system and a method pertain to presenting a link to media usage support in a device driver user interface, and providing media usage support to the user when the link is selected by the user.

### BACKGROUND

Many peripheral devices are configured to manipulate media. For example, peripheral printing devices, such as printers, multifunction peripheral (MFP) devices, and copiers, are configured to draw media from an input tray and print data on the media to generate hard copy documents.

There are several different media types and sizes that can be manipulated by peripheral devices. For instance, suitable print media for a given peripheral device may include sheets of paper, transparencies, envelopes, labels, and the like of various weights and sizes. However, not all peripheral devices are configured to manipulate all types and/or sizes of media. Moreover, peripheral devices may have certain input trays in which certain types and/or sizes of media can be handled, and other input trays that handle other types and/or sizes of media.

Various resources are normally available to the user to determine which media can be used with what peripheral devices and/or what input trays. For instance, user manuals are often provided along with peripheral devices that list the types and sizes of media that may be used with the peripheral device and with which input trays of the device. In addition, the same or similar information is often made available online at, for example, a web site of the device manufacturer. Unfortunately, it is typically difficult and/or tedious for the users to find the information they need. For example, in the case of user manuals, such manuals are typically long and not very user friendly. Similarly, in the case of online web sites, it can be difficult for the user to locate the needed information in the morass of information that is typically provided in a given web site.

In view of the difficulty with locating information regarding media usage, users often take a trial and error approach to media usage with their peripheral devices. In such cases, if the selected media is not supported by the peripheral device and/or the tray the user has loaded the media into, undesired results can occur ranging from unsatisfactory output (e.g., poor print quality) to device damage. In the former case, the user wastes media as well as time. In the latter case, the user may need to spend time and money in repairing the damaged device. Therefore, it can be appreciated that it would be desirable to have a more convenient way to access media usage support for a peripheral device.

### SUMMARY

Disclosed are systems and methods for providing media usage support to a device user. In one embodiment, a system and a method pertain to presenting a link to media usage support in a device driver user interface, and providing media usage support to the user when the link is selected by the user.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which support can be provided to a peripheral device user.

FIG. 2 is a block diagram of an embodiment of the user computer shown in FIG. 1.

FIG. 3 is a flow diagram that illustrates an embodiment of a method for providing support to a peripheral device user.

FIG. 4 is a flow diagram that illustrates an embodiment of operation of a peripheral device driver of the user computer of FIG. 2.

FIG. 5 is a schematic depiction of a user interface associated with the peripheral device driver of the user computer of FIG. 2.

### DETAILED DESCRIPTION

As described above, it is typically difficult and/or tedious for peripheral device users to find the information they need regarding the media capabilities of their peripheral devices. However, as is disclosed herein, if such support is provided using the device driver user interface, access to the needed information can be provided at a place at which the user is likely to see it. Accordingly, the user can be provided with information regarding suitable media types and sizes for the user's particular peripheral device and/or input trays before attempting to use given media.

Disclosed herein are embodiments of systems and methods for providing media usage support to a user. Although particular embodiments are disclosed, these embodiments are provided for purposes of example only to facilitate description of the disclosed systems and methods.

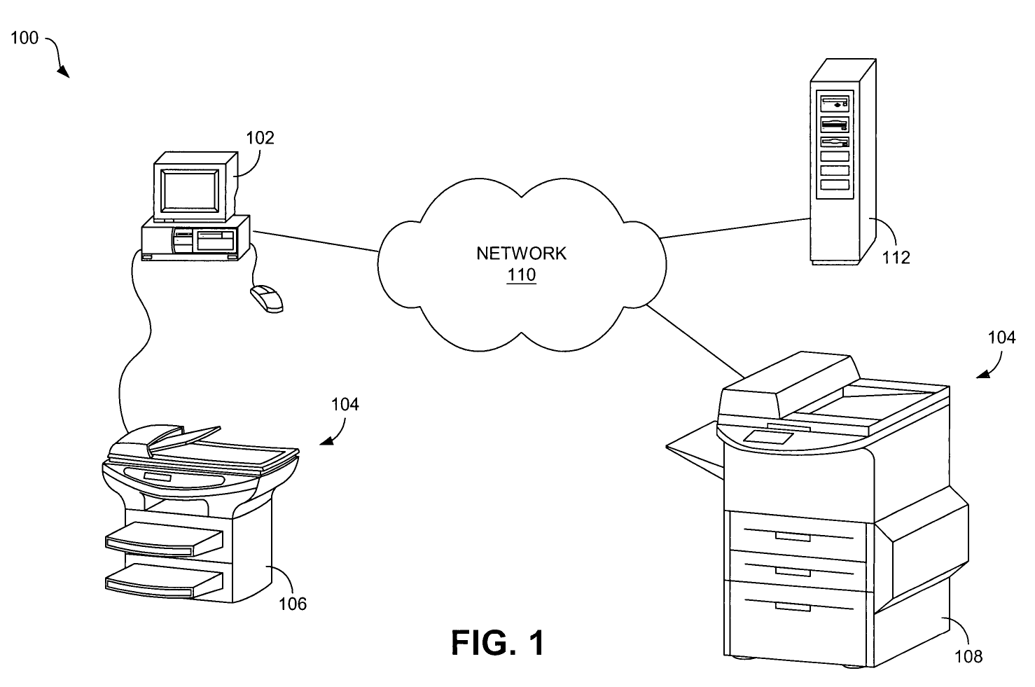

Referring now in more detail to the drawings, in which like numerals indicate corresponding parts throughout the several views, FIG. 1 illustrates a system 100 for providing media usage support to a peripheral device user. As indicated in that figure, the system 100 comprises a user computer 102, such as a desktop personal computer (PC), and one or more peripheral devices 104 with which the computer can communicate. In the embodiment of FIG. 1, the peripheral devices 104 comprise printing devices that can generate hard copy output. Such printing devices can comprise a local printing device that is directly connected to the user computer 102, such as a multifunction peripheral (MFP) device 106 that is capable of multiple functionalities such as printing, copying, scanning, emailing, and faxing. Alternatively or in addition, printing devices can include a remote printing device, such as a printer 108, that the user computer 102 communicates with via a network 110.

Although printing devices are illustrated in the figures and explicitly identified herein, the peripheral devices 104 may comprise any device that is used in conjunction with the user computer 102 so as to be “peripheral” to that computer. More particularly, the peripheral devices 104 comprise any device whose operation is controlled using software that executes on the user computer 102 (e.g., one or more device drivers) and that is adapted to manipulate media.

In addition to the above-noted components, the system 100 may further comprise a remote computer 112. By way of example, the remote computer 112 comprises a network server that stores various information about peripheral devices 104. Optionally, the remote computer 112 may be maintained by or on the behalf of the manufacturer of the peripheral devices 104.

The network 110 may comprise one or more of a local area network (LAN) and a wide area network (WAN). Moreover, the network 110 may comprise a plurality of sub-networks that together form a part of the Internet. In such a case, the remote computer 112 may comprise a web server.

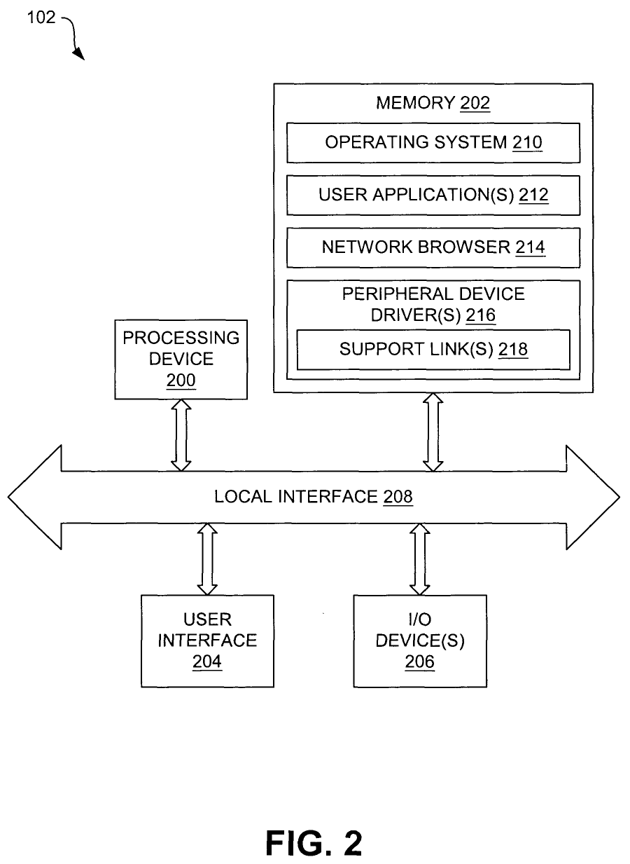

FIG. 2 is a block diagram illustrating an example architecture for the user computer 102. As indicated in FIG. 2, the user computer 102 comprises a processing device 200, memory 202, a user interface 204, and at least one I/O device 206, each of which is connected to a local interface 208.

The processing device 200 can include a central processing unit (CPU) or an auxiliary processor among several processors associated with the computer 102, or a semiconductor based microprocessor (in the form of a microchip). The memory 202 includes any one of or a combination of volatile memory elements (e.g., RAM) and nonvolatile memory elements (e.g., read only memory (ROM), hard disk, tape, etc.).

The user interface 204 comprises the components with which a user interacts with the user computer 102, such as a keyboard and mouse, and a device that provides visual information to the user, such as a cathode ray tube (CRT) or liquid crystal display (LCD) monitor.

With further reference to FIG. 2, the one or more I/O devices 206 are adapted to facilitate communication with other devices, including the peripheral devices 104 (FIG. 1). By way of example, the I/O devices 206 may include one or more of a universal serial bus (USB), a Firewire, or a small computer system interface (SCSI) connection component and/or network communication components such as a modem or a network card.

The memory 202 comprises various programs including an operating system 210, at least one user application 212, a network browser 214, and at least one peripheral device driver 216. The operating system (O/S) 210 controls the execution of other programs and provides scheduling, input-output control, file and data management, memory management, and communication control and related services. The at least one user application 212 comprises one or more programs with which the user may generate data to be provided to the peripheral device. For example, the at least one user application 212 may comprise a word processing application and a computer-aided drawing (CAD) program with which textural and graphical data can be generated and sent to a peripheral device for printing.

The network browser 214 is a program that enables the user to collect and view data accessible via a network, such as the Internet. By way of example, the network browser 214 comprises an Internet browser such as Microsoft Internet Explorer™ or Netscape Navigator™.

Each peripheral device driver 216 comprises a program that is used to control and operate a peripheral device. The drivers 216 comprise code that act in the capacity of translators between programs that execute on the user computer 102 (e.g., user applications 212) and the peripheral device for which the driver is designed. The drivers 216 therefore accept generic commands from a program, and then translate the commands into specialized commands for the peripheral device. In addition to that code, the driver 216 comprises the various code used to support a user interface (described below) that enables the user to make various peripheral device selections.

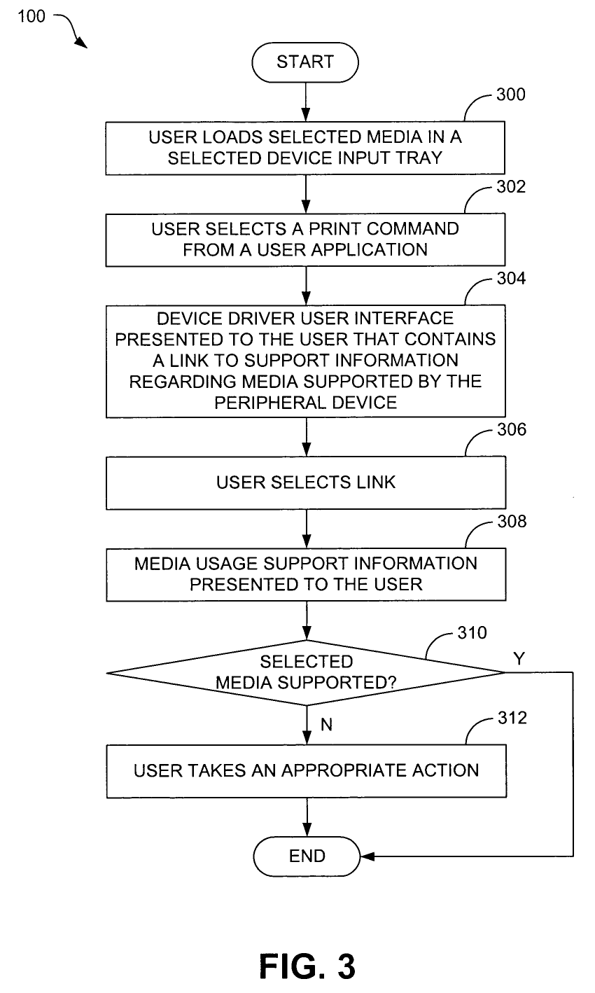

As is indicated in FIG. 2, each peripheral device driver 216 includes one or more support links 218 that facilitate the provision of support to a user. As is described in greater detail below, the support links 218 can comprise hyperlinks that take the user to the remote computer (e.g., web server) of the manufacturer of the peripheral device. More particularly, the support links 218 can comprise hyperlinks that take the user to one or more particular network pages (e.g., web pages) of a network site (e.g., web site) that provide information about media that can be used with the peripheral device. Such operation is described below in relation to FIGS. 3-5.

Various programs (i.e., logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 3 provides an overview of an example of providing support to a peripheral device user in the context of the system 100 shown in FIG. 1. More particularly, FIG. 3 provides an overview of an example of providing support to a printing device user regarding media usage with a device driver user interface. Beginning with block 300 of FIG. 3, the user loads a selected peripheral device input tray with a selected media. Notably, the selected media may or may not be supported by the peripheral device, or the media may be supported by the peripheral device, but may or may not be supported by the particular tray in which it has been loaded.

Next, at the user computer (e.g., computer 102 (FIG. 1)), the user selects a “print” command from a user application, as indicated in block 302. For instance, the user may select “file” from the user application to summon a drop-down menu, and then select a “print” option from the drop-down menu. Alternatively, the user may simply select a “print” button that is presented in a toolbar of the user application. At this time, a device driver user interface is presented to the user which is supported by the peripheral device driver 216 that executes on the user computer, as indicated in block 304. In cases in which the user selected a “print” option from a presented menu (e.g., from the “file” menu), this user interface may, for instance, comprise one or more pop-up boxes that comprise selectable “tabs” pertaining to given peripheral device and/or print job options. By way of example, such tabs may comprise a media tab that, when selected, presents the user with various available options pertinent to the media that will be used for a print job on the peripheral device. In some cases, such tabs are presented to the user after the user selects an appropriate option that permits the user to make relatively low-level device selections, such as a “Properties” button. Alternatively, in a scenario in which the user simply selected a “print” button from a toolbar, a pop-up box may appear independently of tabs and/or other information.

As is further indicated in block 304, the device driver user interface contains a link to support information regarding the media that is supported by the peripheral device, as well as the particular device input trays. In situations in which various types of information and/or options are provided with the user interface, such a link is provided at a location in the user interface at which the user is most likely to see it when making selections regarding media. By way of example, the link is provided in association with a media tab such as that described above. Regardless, the link can comprise, for example, a group of words or a support button that the user can select, for instance by “clicking” on the words or button using a mouse.

If the user would like to be provided with information regarding the supported media (e.g., if this is the first time that the user has used the selected media or a particular peripheral device input tray, or if the user encountered problems with a previous printing attempt), the user can select the link, as indicated in block 306. Next, with reference to block 308, media usage support information is presented to the user. In particular, information regarding media types, sizes, and weights is provided as to the particular model of peripheral device that is being used, and any superfluous information is omitted. By way of example, this support information can be presented in a document, site, or page that is accessed via a network and can be viewed in a viewing window of a network browser that executes on the user computer. In such a case, the link may comprise a hyperlink to an appropriate web file, for instance maintained by or on the behalf of the peripheral device manufacturer. Selection of such a link causes a network browser to launch (if not already active) and retrieve the support information. In an alternative arrangement, selection of the link calls up a file already resident on the user computer (e.g., as part of the driver 216) that contains the support information.

The user can then peruse the presented support information. From that perusal, the user can quickly and easily determine whether the selected media is supported by the peripheral device and/or the particular selected input tray, as indicated in decision block 310. If so, no further action is required in relation to the media selection and/or placement and the user may simply continue the printing process. If, on the other hand, the media is not supported for one reason or another, the user can take an appropriate action to avoid wasting media and/or damaging the peripheral device, as indicated in block 312. Such action may comprise selecting a different type, size, or weight of media, or placing the media in a different input tray that supports that media.

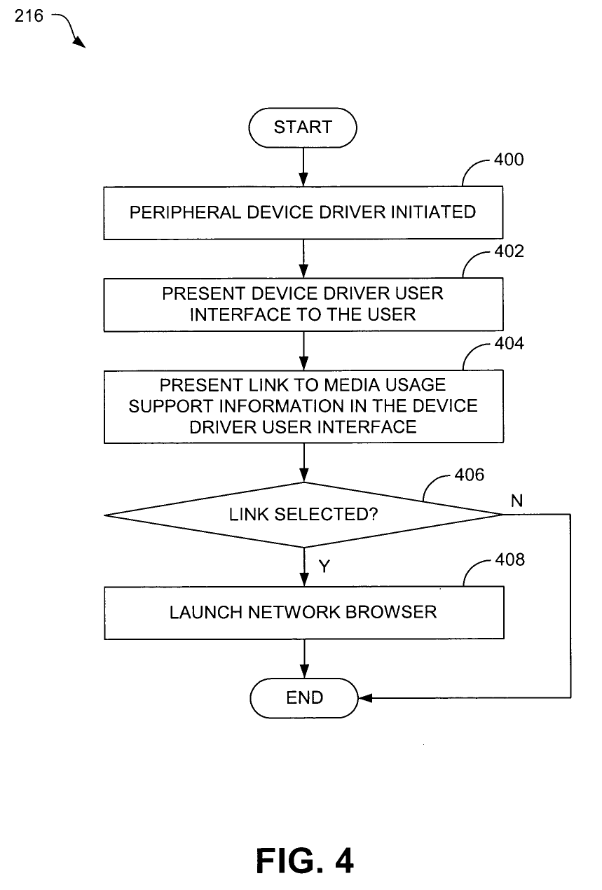

FIG. 4 provides an example of operation of a peripheral device driver 216 that executes on the user computer 102 (FIG. 2) in providing media usage support to a peripheral device user regarding a given peripheral device and its input trays. Beginning with block 400 of FIG. 4, the peripheral device driver 216 is initiated. As noted above, this initiation can occur upon the user selecting a “print” option or button from an appropriate user application 212. Alternatively, the driver 216 may be initiated upon selection of an icon representing the peripheral device for example presented in a control panel support by the O/S 210. Once activated, the peripheral device driver 216 presents a device driver user interface to the user, as indicated in block 402. For instance, the device driver user interface can comprise one or more pop-up boxes.

The device driver user interface presents a link to media usage support information, as indicated in block 404, at some location within the user interface. Such a link may be provided immediately upon initiation of the driver 216. Alternatively, the link may be provided in association with a media tab that is accessed by the user after selecting a “Properties” button of the user interface.

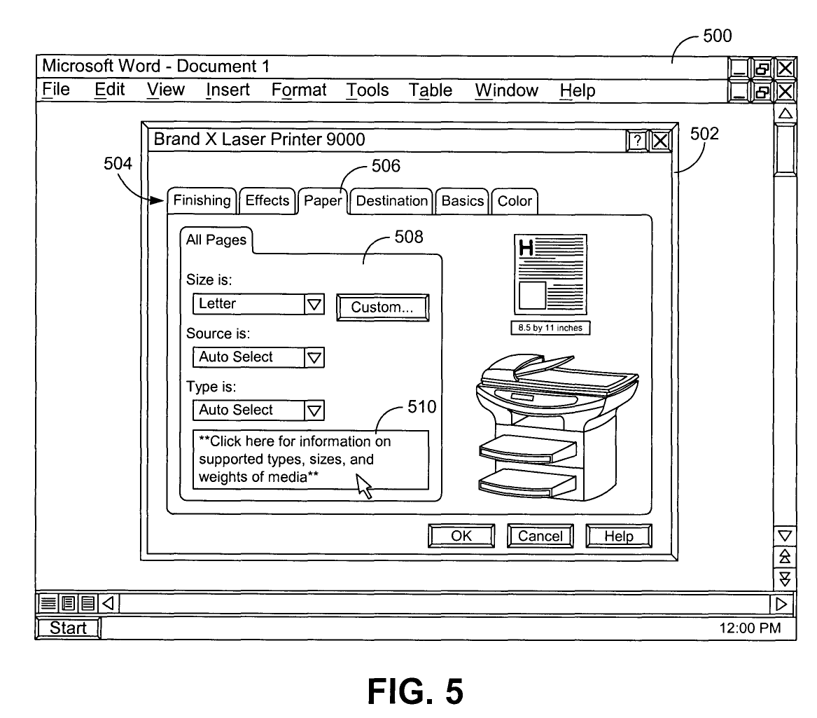

FIG. 5 provides an example of a device driver user interface in presenting a media usage support link. As indicated in FIG. 5, the user has arrived at the user interface from a window 500 of a user application, which in the example of FIG. 5 comprises Microsoft Word™. The device driver user interface comprises a pop-up box 502 that overlaps the user application window 500 and that includes various tabs 504 that lead to various options that the user can specify. As shown in FIG. 5, the user has selected a “Paper” tab 506 that presents the user with various information and options regarding the media that is to be used with the given peripheral device (the “Brand X Laser Printer 9000” in FIG. 5).

In the example of FIG. 5, the information and options are presented in a window 508 associated with the “Paper” tab 506. Within that window 508 is a link 510 that reads: “**Click here for information about supported types, sizes, and weights of media**”. By way of example, the link 510 comprises a hyperlink to a web document, site, or page.

Returning to FIG. 4, the peripheral device driver 216 determines whether the link is selected by the user, for instance by “clicking” on the link using a mouse. If not, no action in providing further information to the user regarding supported media is required, and flow for the support session is terminated. If, on the other hand, the link is selected, the peripheral device driver 216 launches (or causes to be launched) the user's network browser 214, as indicated in block 408, such that appropriate support information is accessed by the browser and provided to the user. Again, the support information may be provided in a web document, site, or page. Such files may be accessed from the remote computer 112, which may, in some cases, comprise a web server.

By way of example, the support information may be contained within a web page of a web site hosted by or on the behalf of the peripheral device manufacturer. In such a case, the user need not conduct searches of the web site (which may be large and/or confusing to the user) and instead is sent directly to the information (e.g., pages(s)) that the user wishes to obtain. The support information can comprise, for instance, a listing of each type, size, and weight of media that is supported by each input tray of the peripheral device. For instance, identified according to input tray can be the various types of media that is supported whether it be sheets of paper, transparencies, envelopes, or the like; the maximum and minimum sizes supported for each type of media; and the maximum and minimum weights supported for each type of media.

From the presented media usage support information, the user can obtain the knowledge that the user needs to avoid wasting media (e.g., due to poor print quality) as well as device damage. Therefore, improved results can be obtained by the user without the need to waste time and/or contact product support representatives.

1. A method for providing media usage support to a device user, the method comprising:
presenting a link to media usage support in a device driver user interface; and
providing media usage support to the user when the link is selected by the user.

2. The method of claim 1, wherein presenting a link comprises presenting a hyperlink to a network file.

3. The method of claim 2, wherein presenting a hyperlink to a network file comprises presenting a hyperlink to one or more of a web document, a web site, and a web page.

4. The method of claim 1, wherein presenting a link comprises presenting a link in association with a media tab of the device driver user interface.

5. The method of claim 1, wherein providing media usage support comprises providing media usage support information in a network browser that retrieves the support information from a network.

6. The method of claim 1, wherein providing media usage support comprises providing media usage support information retrieved from a web server by an Internet browser via the Internet.

7. The method of claim 1, wherein providing media usage support comprises presenting information regarding media types, sizes, and weights for each input tray of a device.

8. A system for providing media usage support to a device user, the system comprising:
means for controlling a peripheral device from a user computer;
means for interfacing with the means for controlling;
means, included within the means for interfacing, for presenting media usage support information obtained via a network.

9. The system of claim 8, wherein the means for controlling comprise a peripheral device driver that executes on the user computer.

10. The system of claim 8, wherein the means for interfacing comprise a device driver user interface that is presented to the user in a display of the user computer.

11. The system of claim 8, wherein the means for presenting media usage support information comprise a hyperlink to a network file.

12. The system of claim 11, wherein the means for presenting media usage support information further comprise a network browser with which the information may be viewed.

13. The system of claim 8, wherein the means for presenting media usage support information comprise means for presenting information including one or more of suitable media types, sizes, and weights for each input tray of the peripheral device.

14. A system stored on a computer-readable medium, the system comprising:
logic configured to operate and control a peripheral device;
logic configured to support interaction between a user and the logic configured to operate and control;
logic configured to enable provision of information regarding what media can be used with the peripheral device retrieved from a network, the logic configured to support interaction being contained within the logic configured to operate and control a peripheral device.

15. The system of claim 14, wherein the logic configured to operate and control comprises a peripheral device driver.

16. The system of claim 14, wherein logic configured to support interaction comprises a device driver user interface.

17. The system of claim 14, wherein the logic configured to enable provision of information comprises a hyperlink to a network file.

18. The system of claim 17, wherein the logic configured to enable provision of information further comprises a network browser.

19. A peripheral device driver user interface, the interface comprising:
a window that is viewable in a computer display;
information and options associated with the peripheral device and its operation presented within the window; and
a link to network-accessible media support information that explains what types, sizes, and weights of media may be used with the peripheral device.

20. The interface of claim 19, wherein the hyperlink is associated with a media tab presented in the window.

21. The interface of claim 19, wherein the link is associated with information that explains what types, sizes, and weights of media that can be used with various input trays of the peripheral device.
